(19) United States
(12) Patent Application Publication
(10) Pub. No.: US 2021/0076902 A1
(43) Pub. Date: Mar. 18, 2021

(54) LINT ROLLER

(71) Applicant: EASY-DO PRODUCTS LIMITED, North Finchley (GB)

(72) Inventor: Daniel Mark NEUMANN, North Finchley (GB)

(21) Appl. No.: 16/955,602

(22) PCT Filed: Dec. 12, 2018
(86) PCT No.: PCT/GB2018/053612

§ 371 Date: Jul. 6, 2020

(30) Foreign Application Priority Data
Dec. 21, 2017 (GB) 1721580.7

(51) Int. Cl. A47L 25/00

(52) U.S. Cl. CPC A47L 25/005

(57) ABSTRACT

Disclosed is a lint roller having a handle by which the lint roller may be gripped and held and with an elongate spindle for carrying an encircling replaceable lint catching roll, wherein the handle grip is an elongate canister/tubular housing that the spindle and lint-catching roll may be slidingly inserted into and housed within when the lint roller is not in use; and the lint roller further has a bi-directional coupling body, the coupling body having a coupling device configured whereby the handle may be attached in one orientation to act as a handle or de-mounted and attached in an opposing orientation to act as the housing for the lint-catching roll. The coupling device preferably includes a unitary screw thread around the circumference of the coupling body at an intermediate zone along its length whereby the handle may reach it and couple with it from either end of the coupling body.

### FIELD OF THE INVENTION

The present invention concerns improvements in and relating to lint rollers, ie hand held devices incorporating a roller with an external adhesive surface and which are commonly used for removing hairs, lint and other fibers and debris from fabrics.

### BACKGROUND TO THE INVENTION

Lint rollers are a popular grooming tool for simple, efficient removal of loose human or pet hairs, lint/fibers, fluff, loose dirt and debris from the surface of textile fabric clothing such as woolen jackets and trousers. Most lint rollers comprise a handle grip with an attached spindle for carrying an encircling replaceable roll of adhesive tape, with one side of the tape having an adhesive coating to pick up the lint and dirt. In some newer lint rollers, rather than having a separate adhesive tape roll, the roller itself has a re-usable/washable outer cylindrical surface of an elastomeric material such as silicone to capture the lint. Lint rollers of either form are generally more effective than brushes at removing lint and other fibers from textile fabric but on the whole lint rollers of the traditional adhesive tape type can be more reliable/effective in practice than the newer re-usable/washable types.

Lint rollers can be provided in a small pocket-sized portable form factor convenient to carry in a pocket or handbag for use on the go. The smallest of these may comprise a switch-knife-like configuration with an elastomeric-surfaced washable roller hinged to an end of a concave hollow handle half shell that the roller can fold/nest into when stowed and which when the roller is folded out holds the roller longitudinally extended beyond the end of the handle and enables the lint roller to be used. Such lint rollers are compact and convenient but they can be costly to manufacture, they can be awkward to operate and they are vulnerable to becoming jammed in open or closed state. Their design furthermore does not lend itself to straightforward modification to allow removal of the lint-catching roll.

The prior art compact portable lint rollers are not optimally suited for their task. It is an objective of the present invention to provide an improved lint roller that is compact and readily portable in a pocket or handbag yet being cost-efficient to manufacture and reliable in use. The lint roller can also be well suited for easy replacement of the lint-catching roll.

### SUMMARY OF THE INVENTION

A lint roller that comprises a handle by which the lint roller may be gripped and held and with an elongate spindle for carrying an encircling replaceable lint catching roll, wherein the handle grip is a housing that the spindle and lint-catching roll may be housed within when the lint roller is not in use; and the lint roller further has a bidirectional coupling body, the coupling body having coupling means whereby the handle may be attached in one orientation to act as a handle or de-mounted and attached in an opposing orientation to act as the housing for the lint-catching roll.

Suitably the handle is an elongate canister/tubular housing that the spindle and lint-catching roll may be longitudinally slidingly inserted into from one end and housed within.

Particularly preferably the coupling means comprises at least one screw thread on the coupling body. Said at least one screw thread may comprise at least one thread ridge. In preferred embodiments, the coupling body is an approximately cylindrical body. Particularly preferably the coupling means comprises a unitary screw thread around the circumference of the coupling body. Preferably the coupling body has the unitary screw thread at an intermediate zone along its length that the handle may reach and couple with from either end of the coupling body. Said unitary screw thread of the coupling body may comprise a single-thread, double-thread, triple-thread, quadruple, or multi-thread screw thread.

Preferably the handle has at least one complementary screw thread to cooperatively engage with said at least one screw thread of the coupling body. Said at least one screw thread of the handle may comprise at least one thread ridge. Preferably the complementary screw thread of the handle and/or coupling body is adapted to avoid inadvertent loosening of the handle from the coupling body when fully fastened thereto. Said screw thread of the handle suitably has a leading end and a trailing end. Preferably said screw thread of the handle has at least a portion of reduced pitch at its trailing end. This avoids inadvertent loosening of the handle from the coupling body when fully fastened thereto. As used herein, the term “leading end” of a screw thread is an end of the screw thread which is configured to approach the complementary screw thread of the part it is attachable to, and the term “trailing end” of a screw thread is the opposite end of the screw thread from the leading end. Suitably the leading end of the screw thread of the handle is at or near an open end of the handle and the trailing end of the screw thread is at the opposite end of the screw thread.

Preferably the coupling body has a gripping surface at one end to facilitate gripholding the coupling body when screwing the handle on or off. This suitably is a knurled, ridged or faceted surface. The gripping surface is preferably annular/extends substantially encircling the coupling body. Particularly preferably the coupling body has a respective gripping surface at each end and suitably with a said screw thread in a zone therebetween.

Preferably the lint roller further comprises a retaining cap that is de-mountably mounted to one end of the spindle to retain the lint catching roll in place on the spindle for use and, when de-mounted, allowing the roll to be removed and replaced.

Preferably the coupling body has the spindle integrally assembled or formed thereon projecting from one end of the coupling body. The spindle suitably projects longitudinally of the coupling body.

The lint-catching roll is preferably a roll of adhesive tape on a tube of cardboard or other tubular support, but may instead be a roll with an elastomeric external cylindrical surface, such as for example a plastic roll with a silicone external cylindrical surface. The roll is preferably discrete from and demountable from the spindle.

### BRIEF DESCRIPTION OF THE DRAWINGS

A preferred embodiment of the present invention will now be more particularly described, by way of example, with reference to the accompanying drawings, that show the lint roller and a sequence of steps in using it, refilling it and stowing it, wherein:

FIG. 1 illustrates an isometric view of the compact portable lint roller of the preferred embodiment with the spindle and lint-catching roll extended from the handle ready for use;

FIG. 2 is a view similar to FIG. 1 but with the roll retaining cap demounted to allow the lint-catching roll to be removed and replaced;

FIG. 3 is a view showing the lint-catching roll demounted;

FIG. 4 is a view showing the lint-catching roll in place and the canister handle removed from the first end of the coupling body and being slid over the roll to cover and protect it and to be held in place coupled to that opposing end/spindle end of the coupling body;

FIG. 5 is a view showing the handle/canister securely screwed down onto the spindle-end of the coupling body firmly securing the handle/canister closed with the spindle and roll safely housed inside and fully protected; and

FIG. 6 is a cross-sectional longitudinal view the handle and a close-up view of the internal screw thread of the handle.

### DESCRIPTION OF THE PREFERRED EMBODIMENTS

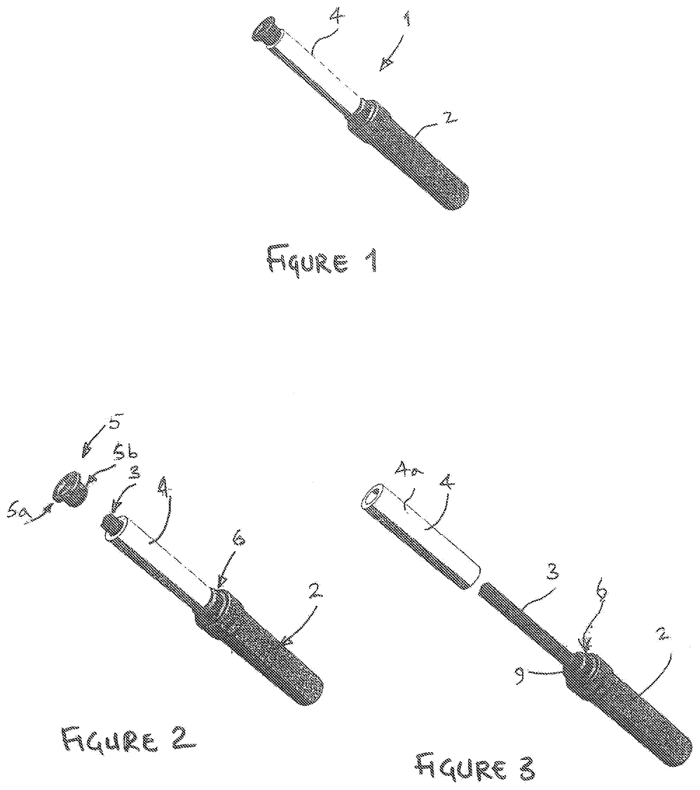

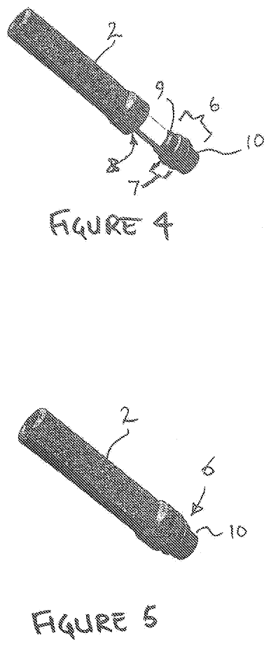

Referring to FIG. 1, the compact portable lint roller 1 comprises a hollow tubular handle 2 by which the lint roller may be gripped and held and with an elongate spindle 3 carrying an encircling replaceable lint catching roll 4. The hollow tubular handle 2 is a canister/tubular housing that is blind/closed at one end and that the spindle 3 and lint-catching roll 4 is housed within when the lint roller is not in use.

The lint-catching roll 4 is illustrated as a roll of adhesive tape with an adhesive external cylindrical surface 4a, the tape being wound or otherwise wrapped on a tube of cardboard or other tubular support, but the roll 4 may instead be a roll with an elastomeric external cylindrical surface, such as for example a moulded plastic roll with a silicone external cylindrical surface. The roll is shown as discrete from and demountable from the spindle 3. A retaining cap 5 is de-mountably mounted to one end of the spindle 3 to retain the lint catching roll 4 in place on the spindle 3 for use and, when de-mounted, allowing the roll 4 to be removed and replaced. The retaining cap 5 suitably has a broad flattened top end 5a that is easy to grasp and beneath that has an annular wall 5b that forms a socket that receives and grips the free end of the spindle 3.

The lint roller 1 has a bi-directional coupling body 6 with a screw threaded outer cylindrical surface 7 to serve as a coupling means whereby the hollow handle 2 may be securely attached in a first orientation to act as a handle for using the lint roller 1, as illustrated in FIG. 1. The coupling body 6 is a short/squat approximately circular cylindrical moulding that has at one end the spindle 3 projecting and extending longitudinally of the coupling body 6. The spindle 3 may be moulded/formed separately of the coupling body 6 but it is integral to it in the end product and is rigidly held projecting from the coupling body 6.

The screw threaded outer cylindrical surface 7 is a unitary screw thread around the circumference of the coupling body 6 and is located at an intermediate zone roughly half-way along the length of the coupling body 6, as best seen in FIG. 5. The screw thread 7 of the coupling body 6 may comprise at least one thread ridge.

The canister-shaped hollow handle 2 has a broad diameter internal circumference at its open end that has a complementary screw thread 8 to cooperatively engage with the screw thread 7 of the coupling body 6. The screw thread 8 of the canister handle 2 is able to couple with the screw thread 7 of the coupling body 6 from either end of the coupling body.

The coupling body 6 has a knurled, ridged or faceted annular grip surface 9 at one end to facilitate grip-holding the coupling body 6 when screwing the handle 2 on or off. A further knurled, ridged or faceted annular grip surface 10 is provided at the other end of the coupling body 6. The screw thread on the coupling body 6 spans the zone between the grip surface 9 at the spindle end of the coupling body 2 and the annular grip surface 10 at the other end.

To use the lint roller 1, it is assembled in the state illustrated in FIG. 1, with the canister handle 2 coupled to the coupling body 6 oriented extending in the opposite direction to the spindle 3 so that the canister handle 2 functions as a handle for the lint roller 2. The screw threaded coupling makes the attachment strong, robust and rigid and renders the tool easy to use efficiently. In that same configuration the lint roller's cap 5 may also be prised off and removed as shown in FIG. 2 so that the lint-catching roll 4 may be removed for cleaning or substitution with a new roll 4.

Once the lint roller 1 has been used it may be re-configured to its stowed compact form by simply gripping the handle 2 and the knurled grip surface 9 of the connector body 2 and turning one relative to the other to unscrew the coupling between the handle's end opening internal thread 8 and the coupling body's external thread 7. The two are then separated and the handle 7 re-oriented to slide over the spindle 3 and screw threadedly attach to the coupling body extending from the spindle end of the coupling body 2. The handle's end opening internal thread 8 simply engages with the coupling body's external thread 7 in that changed orientation and provides a secure sealing and locking closure of the hollow tubular handle 2 against the coupling body 2 accommodating the roll 4 and spindle 3 safely and securely inside. The roll 4 and spindle 3 are thus kept clean between uses and not liable to be lost or damaged when the lint roller is not in use. The whole package is very compact and is easy to use and reliable and effective.

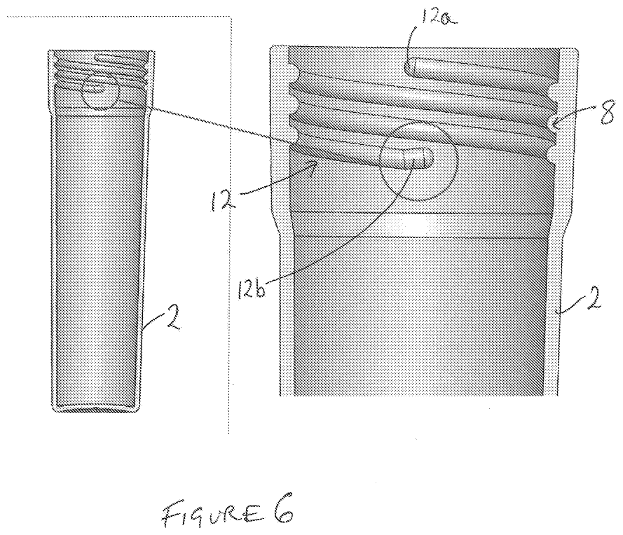

In preferred embodiments the complementary screw thread of the coupling body 6 and/or the handle 2 is optionally adapted so as to avoid inadvertent loosening of the handle 2 from the coupling body 6 once it has been fully attached thereto. This may, for example, be by means of providing the complementary screw threads 7, 8 with anti-backoff means. In one embodiment shown in FIG. 6 the thread 8 of the handle 2 has at least one thread ridge 12 which has a leading end 12a located towards the open end of the handle 2 and a trailing end 12b located away from the open end of the handle 2. The screw thread 7 of the coupling body 6 may also have more than one ridge.

The pitch of the thread 8 is uniform and corresponds to the pitch of the thread 7 of the coupling body 6, except for at the trailing end 12b of the ridge 12 wherein the pitch is reduced slightly to form a ramped tail end at the trailing end 12b of the ridge. The thread 8 has a uniform angle of incline relative to a longitudinal axis of the handle except at the ramped tale end of the trailing end 12b, which has a different angle of incline, forming a portion of reduced pitch. The ramped tail end 12b of the ridge forms an interfering zone whereby when a leading end of a corresponding ridge of the thread 7 of the coupling body 6 reaches the interfering zone, the increased friction between the screw threads, due to the reduced pitch at the interfering zone, retains the handle 2 in its fully fastened configuration. Due to the increased friction as the handle 2 reaches its fastened configuration, once the handle 2 is in its fully fastened configuration, the force required to initially move the handle 2 away from its fastened configuration is greater than the force required to unscrew the handle once this additional friction force has been overcome. This assists in avoiding inadvertent loosening of the handle from the coupling body. This feature effectively locks the handle 2 at an endpoint and provides a stop preventing the handle 2 from further threaded fastening on to the coupling body 6, therefore stopping the handle 2 in the correct position relative to the coupling body.

If the screw thread 8 of the handle 2 has more than one ridge (i.e. forming a double-thread, triple-thread, quadruple, or multi-thread screw thread), the trailing end of each ridge may have a portion of reduced pitch as described above with reference to FIG. 6.

Instead of providing a ramped tail end 12b on the trailing end of a ridge of the internal thread 8 of the handle 2, a similar feature could be provided on the external thread 7 of the coupling body 6 for increasing the friction between the leading end of the thread 8 of the handle and a trailing end of the thread of the coupling body 6.

The threads 7, 8 may be continuous or interrupted. If interrupted, the ridge of each thread will have a leading end and a trailing end with one or more gaps in between the leading and trailing ends.

The screw threads 7, 8 may be single-thread, double-thread, triple-thread, quadruple, or multi-thread screw threads.

In preferred embodiments the coupling body 6 and handle 2 are made of plastic.

1. A lint roller that comprises a handle by which the lint roller can be gripped and held and with an elongate spindle for a lint catching roll, the handle having a handle grip comprising an elongate canister/tubular housing that the spindle and lint-catching roll can be slidingly inserted into and housed within when the lint roller is not in use; and the lint roller further has a bi-directional coupling body, the coupling body having a coupling device configured whereby the handle can be attached in one orientation to act as a handle or de-mounted and attached in an opposing orientation to act as the housing for the lint-catching roll, the coupling device having a unitary screw thread around the circumference of the coupling body at an intermediate zone along the length of the coupling body, and the handle having a complementary screw thread whereby the handle may reach said screw thread and couple with it from either end of the coupling body.

2. A lint roller as claimed in claim 1, wherein the coupling body is an approximately cylindrical body.

3. A lint roller as claimed in claim 1, wherein the coupling body has a gripping surface at one end to facilitate manually grip-holding the coupling

4. A lint roller as claimed in claim 3, wherein the coupling body has a respective gripping surface at each end and with said screw thread in a zone therebetween.

5. (canceled)

6. A lint roller as claimed in claim 1, wherein the complementary screw thread of the handle and/or coupling body is adapted to avoid inadvertent loosening of the handle from the coupling body when fully fastened thereto.

7. A lint roller as claimed in claim 6, wherein the screw thread of the handle has a leading end and a trailing end, said screw thread having at least a portion of reduced pitch at its trailing end.

8. A lint roller as claimed in claim 1, wherein the lint roller further comprises a retaining cap that is de-mountably mounted to one end of the spindle to retain the lint catching roll in place on the spindle for use and, when de-mounted, allowing the roll to be removed and replaced.

9. A lint roller as claimed in claim 1, wherein the coupling body has the spindle integrally assembled or formed thereon projecting from one end of the coupling body.

10. A lint roller as claimed in claim 1 in combination with a lint-catching roll that is mounted encircling the spindle.

11. A lint roller as claimed in claim 9, wherein lint-catching roll is a roll of adhesive tape on a tube of cardboard or other tubular support.

12. A lint roller as claimed in claim 1, wherein said unitary screw thread of the coupling body may comprise a single-thread or a double-thread, triple-thread, quadruple or other multi-thread screw thread.

13. A lint roller as claimed in claim 1, wherein said unitary screw thread of the coupling body may by continuous or interrupted.
